(19) United States
(12) Patent Application Publication
(10) Pub. No.: US 2012/0096893 A1
(43) Pub. Date: Apr. 26, 2012

(54) MOBILE COOLED STORAGE UNITS

(76) Inventors: Nigel William Martin, Warminster (GB); John David Luscombe, Kenilworth (GB)

(21) Appl. No.: 12/451,262

(22) PCT Filed: Apr. 16, 2008
(86) PCT No.: PCT/GB2008/001325

§ 371 Date: Feb. 24, 2011

(30) Foreign Application Priority Data
May 3, 2007 (GB) 0708566.5

(51) Int. Cl. F25D 3/00; B23P 15/26

(52) U.S. Cl. 62/457.9; 29/890.035

(57) ABSTRACT

A mobile cooled storage unit (10) has a sectional racking structure (17) for storing items such as bodies and body parts to be cooled. The racking structure is assembled at a location where the cooling unit is to operate. A removeable insulated outer cover (11) is placed over and supported by the racking structure to enclose the structure and any items stored thereon. A chiller (25) is connected with the interior of the cover for cooling the stored items. Several such units may be connected together to provide a larger overall unit which are cooled by one or more chillers. The invention also provides a method of establishing a temporary cooled storage unit.

This invention relates to mobile cooled storage units which can be used for a variety of uses such as mobile body or body part storage units used to deal with mass fatalities due to natural disasters, pandemic incidents, acts of terrorism and accidents or which can be used as mobile food stores for mass catering situations.

It is an object of the present invention to provide a mobile cooled storage which is quick and straightforward to get into operation and which can maintain a low temperature even in hot climates.

Thus in accordance with the present invention there is provided a mobile cooled storage unit comprising:—
a sectional racking structure for storing items to be cooled, the racking structure being assembled at a location where the cooling unit is to operate;
a removeable insulated outer cover which is placed over and supported by the racking structure to enclose the structure and any items stored thereon, and
a chiller for cooling the interior of the outer cover.

The insulated cover is preferably made from flexible plastics or nylon material with at least one side which has an aperture formed therein for access to the racking structure.

The racking system may have several storage levels with each level having its own access aperture in the insulated cover.

The insulated cover is preferably of a multi-layer construction with outer layers of plastics or nylon material with layers of foil wrapped twin layer air bubble insulation sandwiched therebetween.

The outer cover preferably has a top and four sides, each side being detachably secured around its upper edge to the top and each side being detachably joined to the adjacent sides along its vertical edges.

The or each side which has an access aperture preferably has a series of separately moveable flaps which close the aperture and give access to different levels of the racking structure.

The sides are preferably zipped onto the top and are joined with the adjacent sides by zips or Velcro™ or similar loop and hook securing strips.

Preferably each side which contains the moveable flaps has a frame-like perimeter provided on its outer surface with a border of fastening loops or hooks and each flap is provided with a border of cooperating fastening hooks or loops around the perimeter of its inner surface for fastening on the loops or hooks on the frame-like perimeter, the flaps overlapping each along their horizontally extending upper and lower edges.

An insulated base is preferably provided underneath the racking structure.

The racking structure is preferably of a modular construction comprising vertically spaced shelf units interconnected at their corners by vertically extending tubes, the system being easily assembled at the location where the cooling unit is to operate.

The vertically extending tubes extending between the different shelf units may be of different lengths to cater for the storage of differently sized items in the cooling unit. The different vertical tubes may be colour coded according to their length to assist in the rapid assembly of the racking system.

The outer cover preferably has openings near the top and bottom which are connected with the chiller, chilled air being blown into the interior of the cover near the top and drawn back into the chiller near the bottom of the cover.

Typically when the unit is used as a mobile body or body part storage unit it will accommodate twelve bodies on four levels of shelving and will be a cube of approximately 8 cubic metres.

Several similar units may be interconnected and cooled by one or more chillers.

The storage unit may be provided with an additional containment cover for use outside the insulated outer cover.

The outer containment cover is designed to have a stored position in which full access to the unit is provide and a deployed position in which the containment cover totally encloses the unit.

Preferably the containment cover is held around the unit in the deployed position by a gas-tight zip.

The containment cover may be provided with a venting valve which controls the level of gas pressure inside the deployed containment cover and which also scrubs any air released by the venting valve to reduce or eliminate hazardous gasses, agents, liquids, vapours, etc. which may be given off by the contents of the unit.

The present invention also provides:—
a modified ISO container with an open side or sides;
a racking structure within the ISO container for storing items to be cooled;
a removeable insulated outer cover which is placed over the ISO container, and
a chiller for cooling the interior of the outer cover.

The present invention further provides a method of establishing a temporary cooled storage unit at a location comprising:—
erecting a racking structure for storing items to be cooled at the location;
placing a removeable insulated outer cover over the racking structure to enclose the structure and any items to be stored thereon, and
connecting a chiller to the interior of the outer cover to cool any items stored within the cover.

The present invention will now be described, by way of example only, with reference to the accompanying drawings in which:—

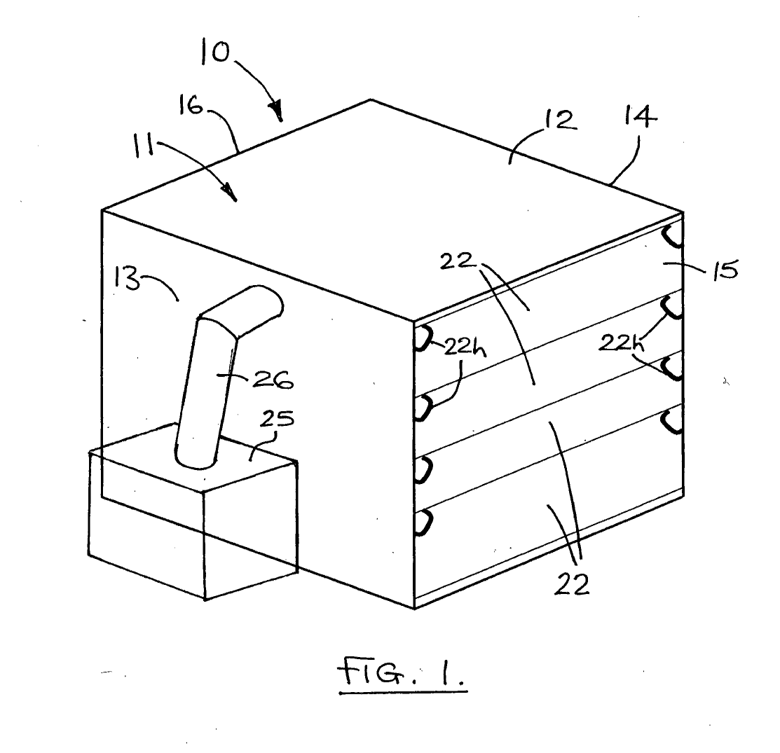

FIG. 1 shows an external perspective view of a mobile cooled body or body part storage unit in accordance with the present invention;

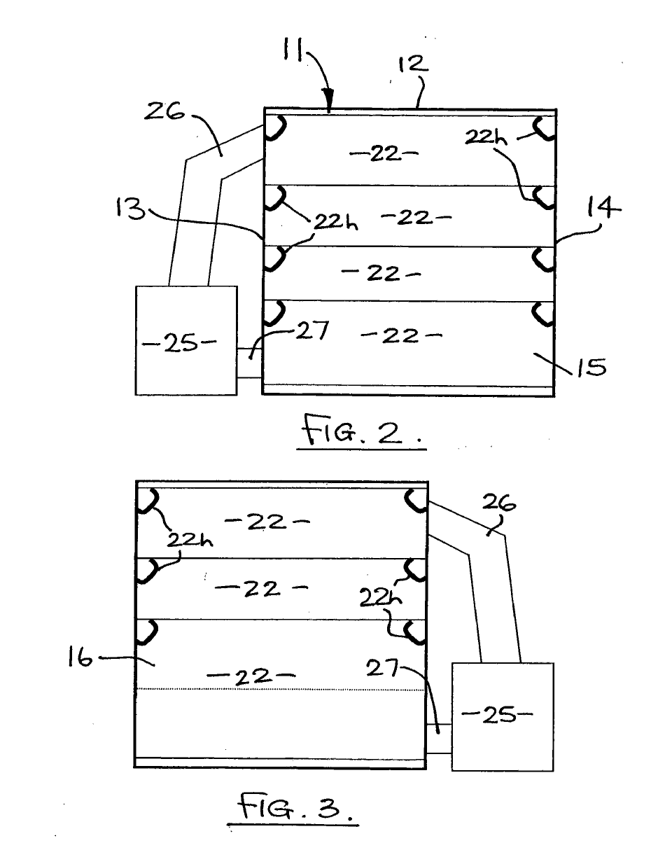

FIGS. 2 and 3 show front and back views of the storage unit of FIG. 1;

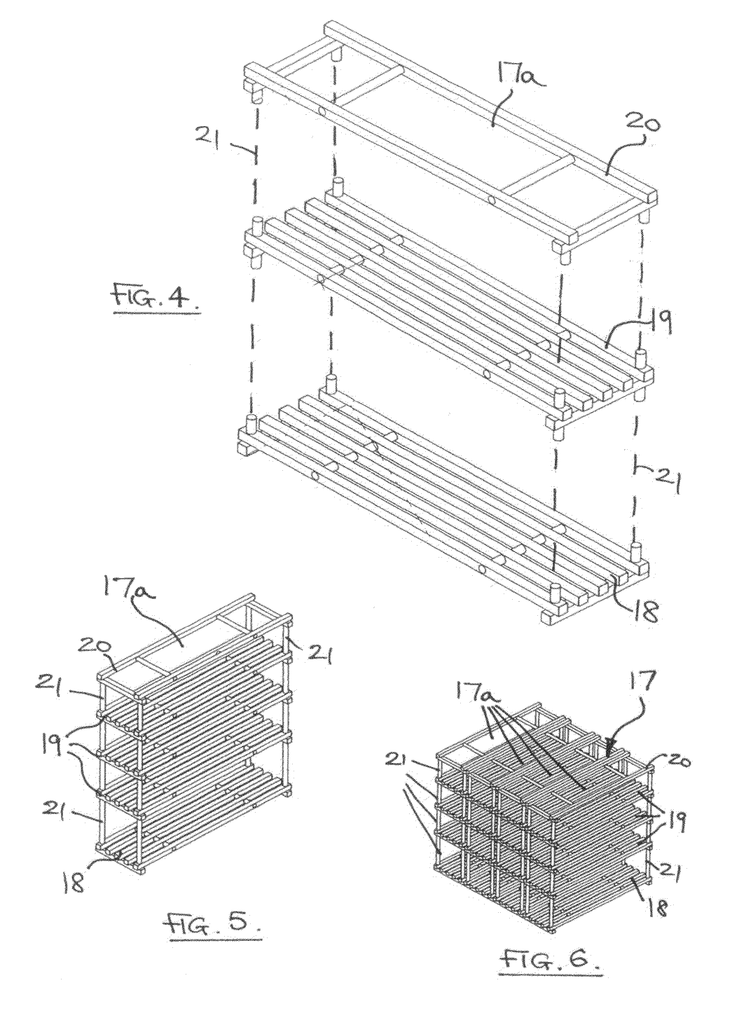

FIGS. 4 to 6 show details of a racking structure used in the storage unit of FIG. 1;

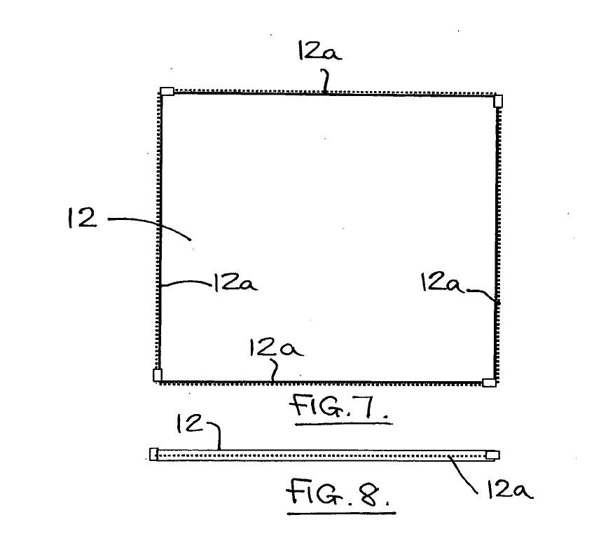

FIGS. 7 and 8 show plan and edge views of the top of the outer cover used in the storage unit of FIG. 1;

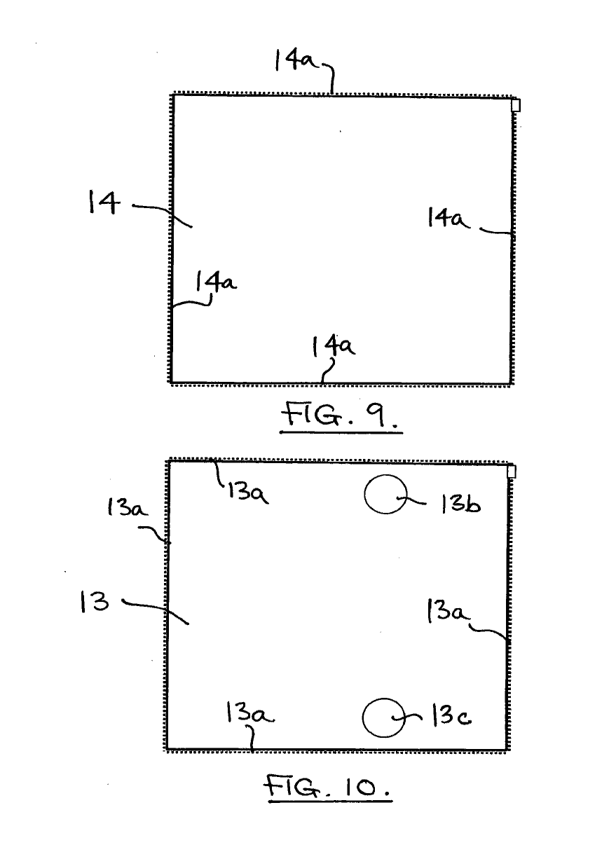

FIGS. 9 and 10 shows details of the sides of the outer cover;

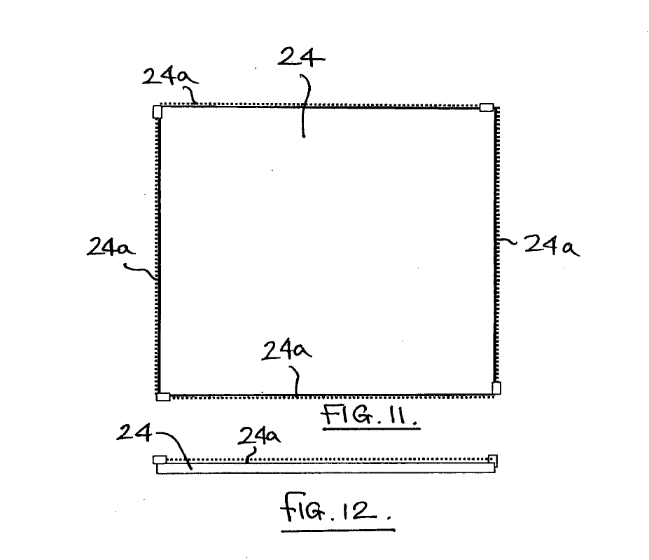

FIGS. 11 and 12 show details of the base of the outer cover;

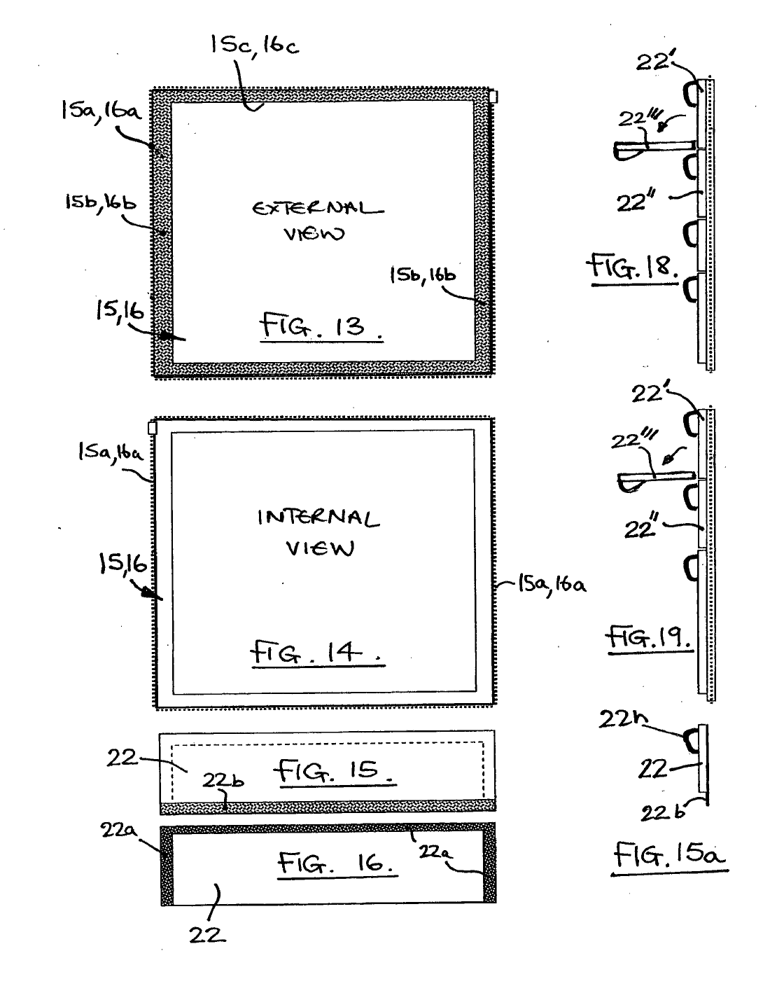

FIGS. 13 and 14 show external and internal details of the front and back of the outer cover;

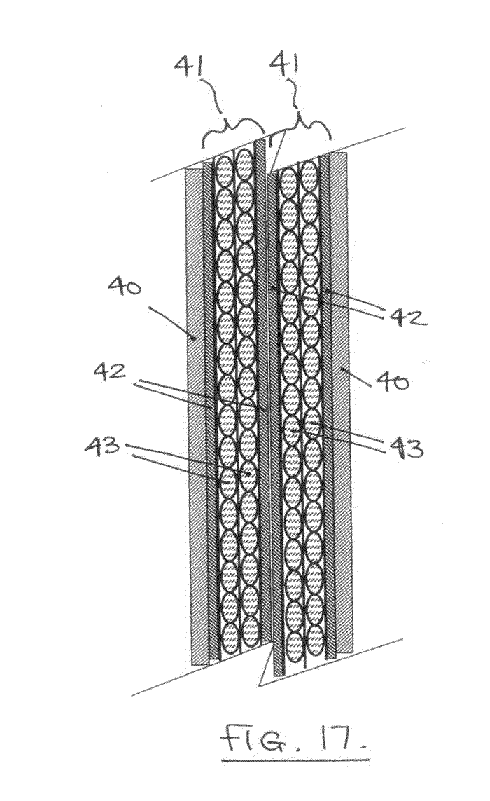

FIGS. 15, 15a and 16 show external, end and internal details of the door flaps used on the front and back of the outer cover;

FIG. 17 shows a cross section through the material of the outer cover;

FIGS. 18 and 19 show details of how the door flaps overlap when in their closed positions for panels with four flaps and three flaps respectively;

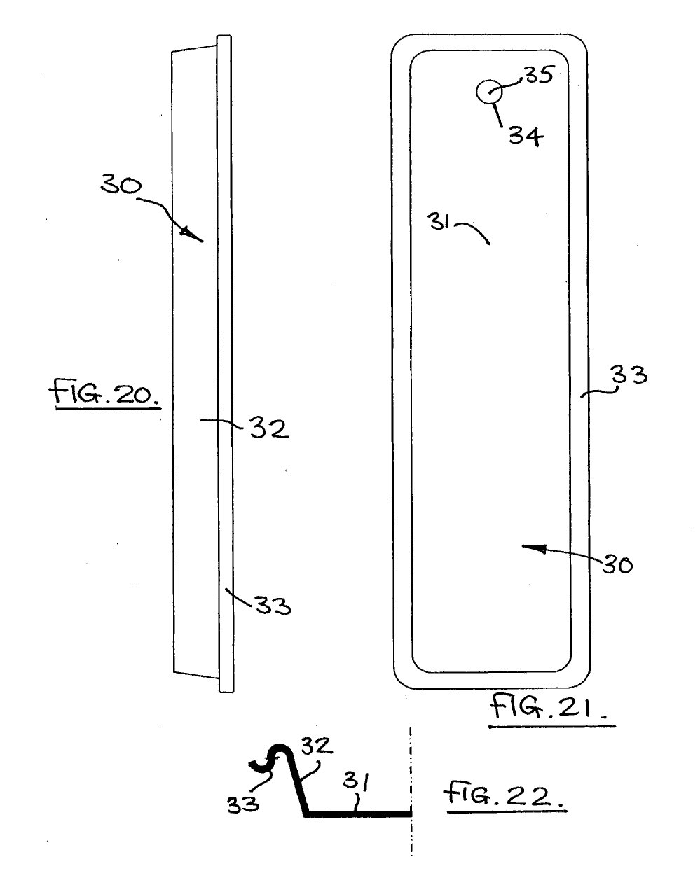

FIGS. 20 to 22 show details of a body tray for use in the storage unit;

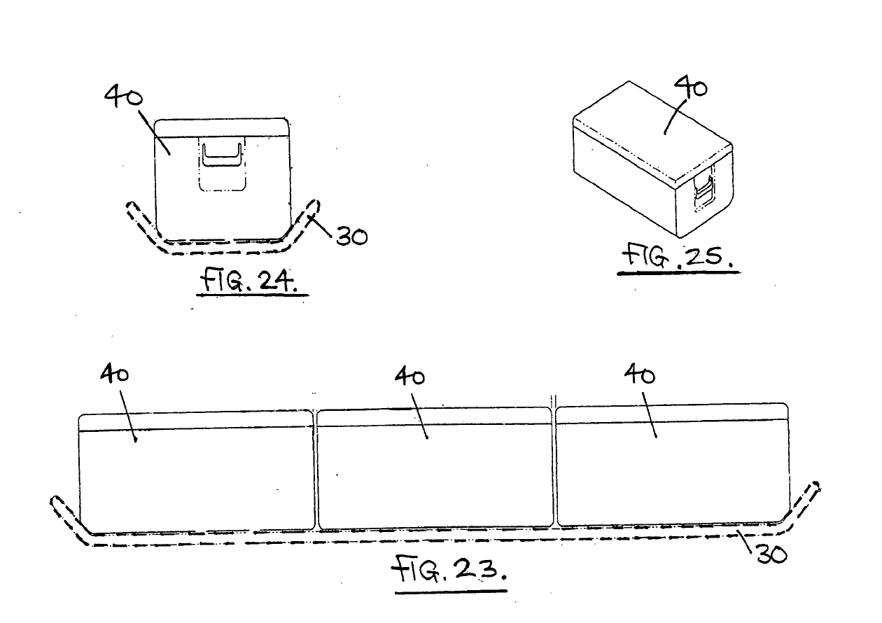

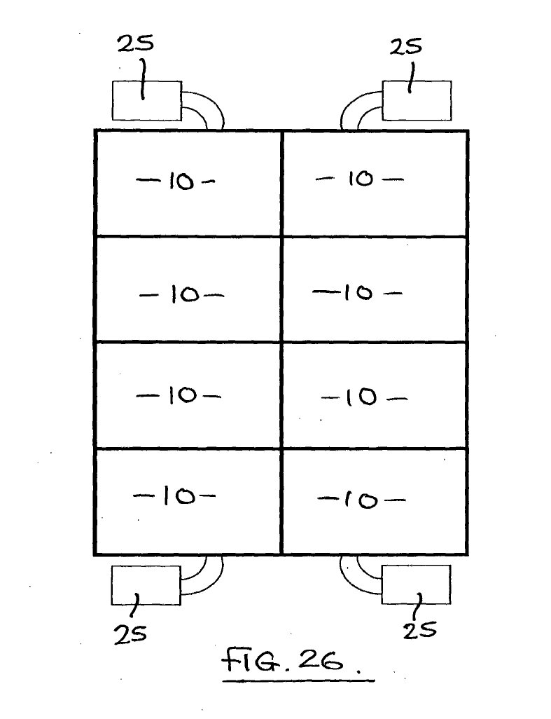

FIGS. 23 to 25 show details of a box for body parts for use in the storage unit;

FIG. 26 shows several storage units connected together to provide a larger storage facility;

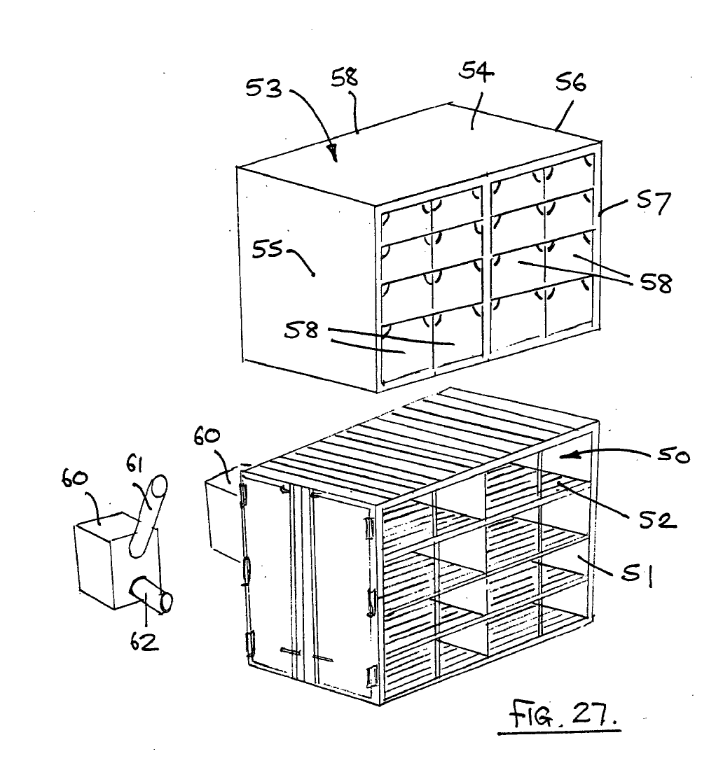

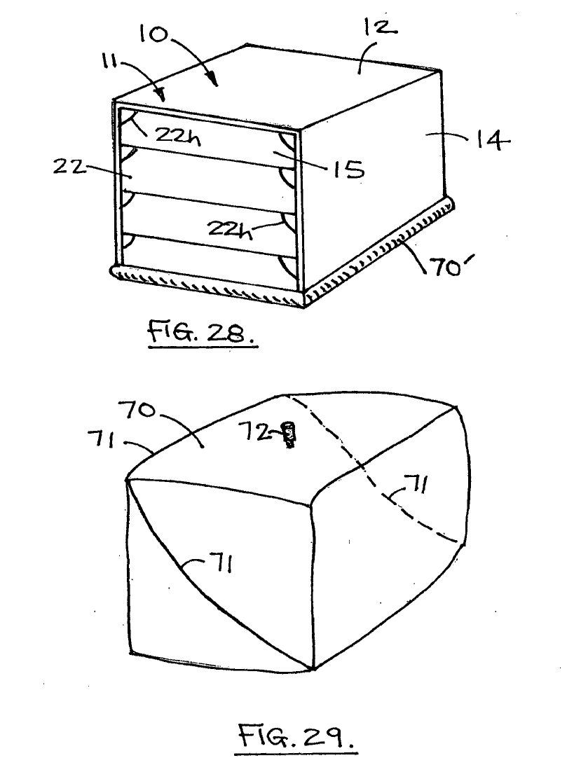

FIG. 27 shows an alternative storage unit which uses a modified ISO container;

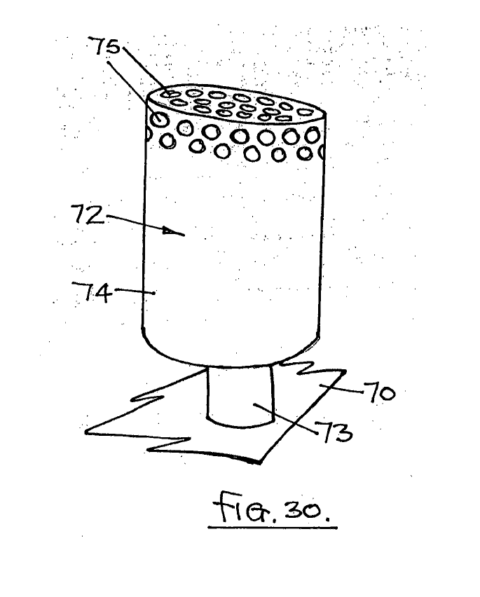

FIGS. 28 and 29 show an additional containment cover for the storage unit in its stored and deployed positions respectively, and

FIG. 30 shows a venting valve used with the containment cover.

Referring to the drawings, a mobile cooled body or body part storage unit 10 has an insulated outer cover 11 which has a top 12 two sides 13 and 14 and a front and back 15 and 16. The top, sides, front and back of the outer insulated cover are all separate components details of which can be seen in FIGS. 7 to 16. These separate components are constructed from insulated material whose cross sectional details are shown in FIG. 17. This material is of a multi-layer plastics or nylon construction having outer layers 40 of heavy weight plastics or nylon material and two inner layers 41 each having foil layers 42 which enclose twin layers of air bubble insulation 43. Any other suitable insulating material could be used in place of the foil wrapped air bubble layers.

The outer insulated cover 11 is placed over a racking structure 17, details of which are shown in FIGS. 4 to 6. The racking structure 17 consists of four racks 17a placed side by side. As shown in FIG. 4 each rack 17a comprises a base shelf 18 and two or three intermediate shelves 19 with a top shelf 20. These shelves are shown in more detail in FIG. 4 and are joined by vertical tubes 21 which may be of different lengths. These different lengths of tubing can conveniently be colour coded to assist in the assembly of the shelving at the location where the storage unit is to be used.

In the arrangement shown in FIG. 6, the racking structure 17 is designed to house twelve bodies on four levels of shelving and to be basically a cube-like structure having a side length of approximately 2 metres giving a total storage capacity of approximately 8 cubic metres. The cover 11 is supported on the top shelves 20.

As can be seen from FIGS. 2 and 3, the front and back 15 and 16 of the outer cover 11, which are of similar construction, one having four door flaps 22 and the other having three door flaps 22. Each door flap has handles 22h and gives access to an individual level of the racking structure shown in FIG. 6. By having different numbers of flaps the insulated cover can cater for a racking structure assembled to have 3 or 4 levels of shelving.

The top 12 of the insulated cover is provided with zip 12a along each edge (see FIGS. 7 and 8). Using these zips the two sides 13 and 14 and the front and back panels 15 and 16 are attached to the top 12.

The two side panels 13 and 14 are of similar construction and, as shown in FIGS. 9 and 10, each panel having zips 13a, 14a along its edges. Side panel 13 includes a chiller inlet 13b adjacent is upper edge and a chiller outlet 13c adjacent its lower edge. Using the zips 13a, 14a the side panels are connected with the top 12, as described above, and also with the vertical edges of the front and back panels 15 and 16.

The front and back panels again have zipped sections 15a and 16a around their edges for attachment to the top panel 12 and the side panels 13 and 14 and are of a frame-like configuration with a large central door aperture 15c, 16c which is closed by either three or four door flaps 22. The outer surface of the front and back panels 15 and 16 are bordered by Velcro (or other loop and hook fastener) strips 15b and 16b as shown in FIG. 13.

The constructional details of the door flaps are shown in FIGS. 15, 15a and 16 and, as can be seen from FIG. 16, the inner face of each door flap is bordered along its vertical sides and upper edge by a strip 22a of Velcro hooks and the lower edge of the outer face of each door flap is provided with a strip 22b of Velcro loops. The door flaps 22 are secured across the door aperture 15c, 16c using the Velcro hooks 22a which engage the Velcro loop strips 15b, 16b which extend along the vertical edges of the front and back panels. FIGS. 18 and 19 shows the way in which the door panels are overlapped when in the closed position so that, for example, the Velcro hooks 22a along the upper inner edge of second the flap 22″ from the top of the storage unit (see FIG. 18) will overlap and engage the strip of Velcro loops 22b along the lower outer edge of the top flap 22′ of FIG. 18. The position of the door flaps when open is shown in dotted detail 22′″ in FIGS. 18 and 19.

The insulated outer cover is completed by a base 24, the details of which are shown in FIGS. 11 to 12. The base 24 is in the form of a shallow tray and is provided with zips 24a around its edges which are connected with the zips on the lower edges of the sides and the front and back panels.

The zips which join the vertical edges of the side panels, to the front and back panels and the zips which join the lower edges of these panels to the base could be replaced by Velcro or similar loop and hook fasteners if desired.

A chiller 25 is connected with the interior of the outer cover via flexible hoses 26 and 27. Hose 26 delivers chilled air into the upper portion of the interior of the cover via inlet 13b and hose 27 draws air from the interior of the cover for returning to the chiller 25 via outlet 13c. Details of the precise chiller are not part of the present invention and any suitable unit could be used. For example, those available from RIVACOLD under model No. PTM009ZR01 for smaller storage units or Model No. PTM022ZR01 for larger units are suitable for cooling storage units of the form described above. Typically such units can maintain a selected temperature in the range +10 to −25 degrees C.

FIGS. 20 to 22 show a body tray 30 moulded from polyethylene or foam filled ABS which consists of a shallow tray with a base 31 and sides 32 which include a carrying lip 33. The base 31 includes a drain hole 34 provided with a plug 35. This body tray is shaped for use on the racking structure shown in FIGS. 4 to 6 but is suitable for other uses also.

FIGS. 23 to 25 show a body parts box 36 which is suitable for use either separately or in conjunction with the body tray shown in FIGS. 20 to 22. As can be seen from FIG. 21 three body boxes are designed to fit in the body tray.

As an additional level of protection an outer containment cover 70 may be provided within which the storage unit 10 stands on its base 24. When the storage unit 10 is in use the cover 70 is rolled to a stored position shown at 70′ in FIG. 28. FIG. 29 shows the cover 70 in its deployed position when it totally encloses the storage unit 10 outside the insulating cover 11 and is held around the storage unit 10 by a gas-tight zip 71. For ease of transportation the complete unit and containment cover would preferably be erected on pallet base or similar so that the whole structure can by transported by forklift truck, crane or similar device.

The containment cover 70 is made from so-called CBRN barrier material, that is, material which provides protection against chemical, biological, radiological and nuclear gasses, agents, liquids, vapours etc. for a period of say 48 to 78 hours. Such a material is available from Gore Technologies. The cover is also provided with a venting valve 72 which includes a pressure relief valve in section 73 which prevents the build up of excessive gas pressure within the sealed cover and a main body section 74 which contains a scrubbing filter which uses carbon or similar filtering material to scrub air which is released from within the cover by the pressure release valve prior to the air escaping into the atmosphere via perforations 75.

Thus venting valve 72 controls the air pressure build up within cover 70 and the discharge of hazardous CBRN gasses, agents, liquids, vapours etc. the unit.

The provision of such a containment cover 70 makes the removal of a storage unit full of bodies to a place of ultimate disposal a less hazardous task.

FIG. 26 shows the manner in which a number of the cooling units can be joined together using their appropriate zips to provide a larger cooling capacity. In the arrangement shown in FIG. 26 eight units are placed side by side and are serviced by only four chillers 25.

Such an arrangement enables a relevantly large body or body part storage capacity to be rapidly assembled in the event of accidents or other severe fatal incidents.

FIG. 27 shows an alternative mobile cooling unit in which a modified ISO container 50 which has open sides 51 has four levels of racking 52 installed inside the container. The ISO container is provided with a removeable cover 53 which is constructed from the insulated material shown in FIG. 17 and which has a top 54, ends 55 and 56, a front 57 and back 58. The front 57 is provided with sixteen door flaps 58 of a similar construction to the door flaps 22 described above which give full access to all the levels of racking 52. Two chillers 60 are connected via flexible hoses 61 and 62 to the interior of the cover 53 via suitable inlets and outlets with one chiller connected to each respective half of the cover.

Such a cooling unit can be rapidly set up and provides a more robust arrangement which is more suitable for certain applications.

If desired, the ISO container 50 may use a sectional racking arrangement similar to the racks 17a described above which may be erected inside the ISO container when the container has been placed in its intended operating position.

Although the invention has been described above in relation to use as a mobile body or body part storage facility, the mobile cooling unit of the present invention can also be used for more pleasant duties such as, for example, a mobile food store used for mass catering situations such as large weddings or other functions which are held in marquees or other similar situations. When used for other applications the racking structure will be sized accordingly.

What is claimed is:

1. A mobile cooled storage unit comprising:—
a sectional racking structure for storing items to be cooled, the racking structure being assembled at a location where the cooling unit is to operate;
a removeable insulated outer cover which is placed over and supported by the racking structure to enclose the structure and any items stored thereon, and
a chiller for cooling the interior of the outer cover.

2. A unit according to claim 1 in which the insulated cover is made from flexible plastics or nylon material with at least one side which has an aperture formed therein for access to the racking structure.

3. A unit according to claim 1 in which the racking structure has several storage levels with each level having its own access aperture in the insulated outer cover.

4. A unit according to claim 1 in which the insulated outer cover is of a multi-layer construction with outer layers of plastics or nylon material with one or more layers of insulation sandwiched therebetween.

5. A unit according to claim 4 in which two layers of foil wrapped twin layer air bubble insulation are sandwiched between the plastics or nylon outer layers.

6. A unit according to claims in which the outer cover has a top and four sides, each side being detachably secured around its upper edge to the top and each side being detachably joined to the adjacent sides along its vertical edges.

7. A unit according to claim 6 in which the sides are zipped onto the top and are joined with the adjacent sides by zips or Velcro or similar loop and hook securing strips.

8. A unit according to claim 2 in which the or each side which has an access aperture has a series of separately moveable flaps which close the aperture and give access to different levels of the racking structure.

9. A unit according to claim 8 in which each side which contains the moveable flaps has a frame-like perimeter provided on its outer surface with a border of fastening loops or hooks and each flap is provided with a border of cooperating fastening hooks or loops around the perimeter of its inner surface for fastening on the loops or hooks on the frame-like perimeter, the flaps overlapping each along their horizontally extending upper and lower edges.

10. A unit according to claim in which an insulated base is provided underneath the racking structure, the base being joined to the lower edges of the sides by zips or loop and hook fasteners.

11. A unit according to claim 1 in which the racking structure is of a modular construction comprising vertically spaced shelf units interconnected at their corners by vertically extending tubes, the system being easily assembled at the location where the cooling unit is to operate.

12. A unit according to claim 11 in which the vertically extending tubes extending between the different shelf units may be of different lengths to cater for the storage of differently sized items in the cooling unit.

13. A unit according to claim 12 in which the different length vertical tubes are colour coded according to their length to assist in the rapid assembly of the racking system.

14. A unit according to claim 1 in which the racking system is of a plastics and/or aluminium construction.

15. A unit according to claim 1 in which the insulated outer cover has openings near the top and bottom which are connected with the chiller, chilled air being blown into the interior of the cover near the top and drawn back into the chiller near the bottom of the cover.

16. A unit according to claim 15 in which the cooler is connected with the openings in the outer cover via flexible hose or trunking.

17. A unit according to claim 1 connected with one or more similar units to form a larger overall unit, the connected units being cooled by one or more chillers.

18. A unit according to claim 1 which is provided with an additional containment cover for use outside the insulated outer cover.

19. A unit according to claim 18 in which the containment cover has a stored position in which full access to the unit is provided and a deployed position in which the containment cover totally encloses the unit.

20. A unit according to claim 19 in which the containment cover is held around the unit in the deployed position by a gas-tight zip.

21. A unit according to claim 18 in which the containment cover is provided with a venting valve which controls the level of gas pressure inside the deployed containment cover and which also scrubs any air released by the venting valve to reduce hazardous gasses, agents, liquids, vapours, etc.

22. A mobile cooled storage unit comprising:—
a modified ISO container with an open side or sides;
a racking structure within the ISO container for storing items to be cooled;
a removeable insulated outer cover which is placed over the ISO container, and
a chiller for cooling the interior of the outer cover.

23. A method of establishing a temporary cooled storage unit at a location comprising:—
erecting a racking structure for storing items to be cooled at the location;
placing a removeable insulated outer cover over the racking structure to enclose the structure and any items to be stored thereon, and
connecting a chiller to the interior of the outer cover to cool any items stored within the cover.

24. (canceled)
